(19) United States
(12) Patent Application Publication
(10) Pub. No.: US 2011/0249176 A1
(43) Pub. Date: Oct. 13, 2011

(54) WAFER LEVEL LENS MODULE AND RELATED METHOD FOR FORMING THE SAME

(76) Inventor: Chuan-Ching Hsueh, Tainan County (TW)

(21) Appl. No.: 12/758,814

(22) Filed: Apr. 13, 2010

(51) Int. Cl. H04N 5/225; G02B 7/02; B32B 37/00

(52) U.S. Cl. 348/374; 156/293; 156/60; 359/503; 348/E05.024

(57) ABSTRACT

A wafer level lens module includes a first optical layer, a spacer layer and a second optical layer. The spacer layer is disposed upon the first optical layer, having a hole through the spacer layer for light passage, wherein a surface of the hole substantially avoids light reflection. And the second optical layer is disposed upon the spacer layer.

### BACKGROUND OF THE INVENTION

1. Field of the Invention

The present invention relates to a wafer level lens module and related method, and more particularly, to a wafer level lens module and related method capable for eliminating/reducing the undesired stray light.

2. Description of the Prior Art

With the advance of optics technology, image-capturing devices are more and more popular in a variety of applications. For example, beside digital cameras, mobile devices such as mobile phones, personal digital assistants, and notebooks also have image-capturing functions installed therein.

A lens module is one of the most important components in the image-capturing device. However, the image sensor disposed below the lens module will be affected by the stray light, thereby causing the noise and degrading the image contrast. Therefore, how to effectively prevent the image sensor from receiving any stray light for boosting the overall performance of the image-capturing device has become an important topic to be solved in the pertinent field.

### SUMMARY OF THE INVENTION

It is one of the objectives of the present invention to provide wafer level lens modules, wafer level cameras and related methods for forming the wafer level lens modules, to solve the abovementioned problems.

According to one exemplary embodiment, a wafer level lens module is provided. The wafer level lens module includes a first optical layer, a spacer layer and a second optical layer. The spacer layer is disposed upon the first optical layer, having a hole through the spacer layer for light passage, wherein a surface of the hole substantially avoids light reflection. And the second optical layer is disposed upon the spacer layer.

According to another exemplary embodiment, a wafer level camera is provided. The wafer level camera includes an image sensor, a spacer layer and a wafer level lens module. The spacer layer is disposed upon the first optical layer, having a hole through the spacer layer for light passage, wherein a surface of the hole substantially avoids light reflection. And the wafer level lens module is disposed upon the spacer layer.

According to another exemplary embodiment, a method of forming a wafer level lens module is provided. The method includes the following steps: providing a first optical layer, a spacer layer, and a second optical layer, wherein there has a hole through the spacer layer for light passage; disposing the spacer layer on the first optical layer, and disposing the second optical layer on the spacer layer; and disposing a specific thin film layer on a surface of the hole.

According to another exemplary embodiment, a method of forming a wafer level lens module is provided. The method includes the following steps: providing a first optical layer, a spacer layer, and a second optical layer; disposing the spacer layer on the first optical layer, and disposing the second optical layer on the spacer layer; and making a hole passing through the spacer have a rough surface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional view showing an architecture of a wafer level camera according to a first embodiment of the present invention.

FIG. 2 is a diagram illustrating an enlarged portion of a spacer layer of the wafer level camera shown in FIG. 1.

FIG. 3 is a cross-sectional view showing an architecture of a wafer level camera according to a second embodiment of the present invention.

FIG. 4 is a diagram illustrating an enlarged portion of a spacer layer of the wafer level camera shown in FIG. 3.

FIG. 5 is a flowchart illustrating a method for forming a wafer level lens module according to an exemplary embodiment of the present invention.

FIG. 6 is a flowchart illustrating a method for forming a wafer level lens module according to another exemplary embodiment of the present invention.

### DETAILED DESCRIPTION

Certain terms are used throughout the following description and claims to refer to particular components. As one skilled in the art will appreciate, hardware manufacturers may refer to a component by different names. This document does not intend to distinguish between components that differ in name but in function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

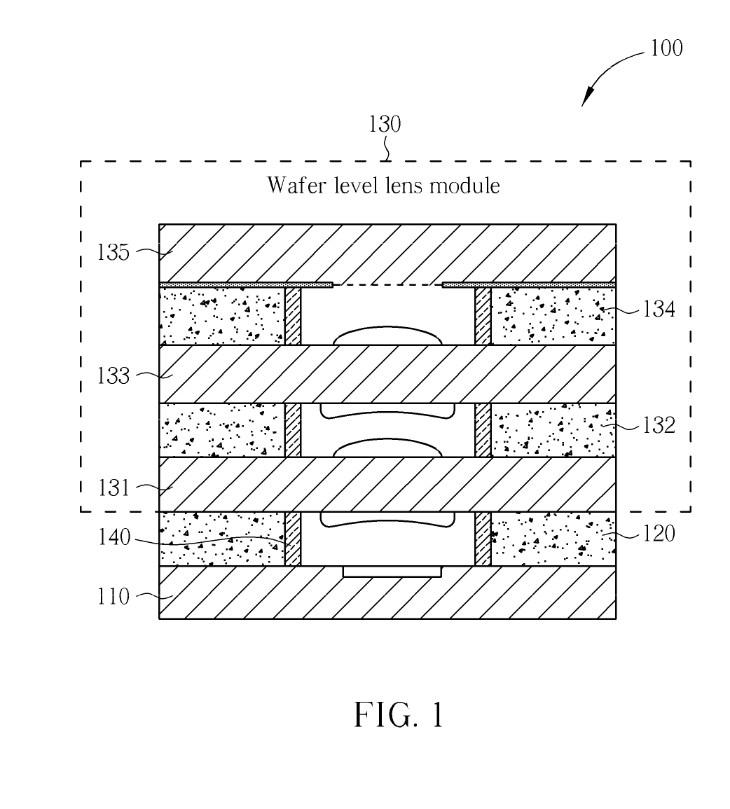

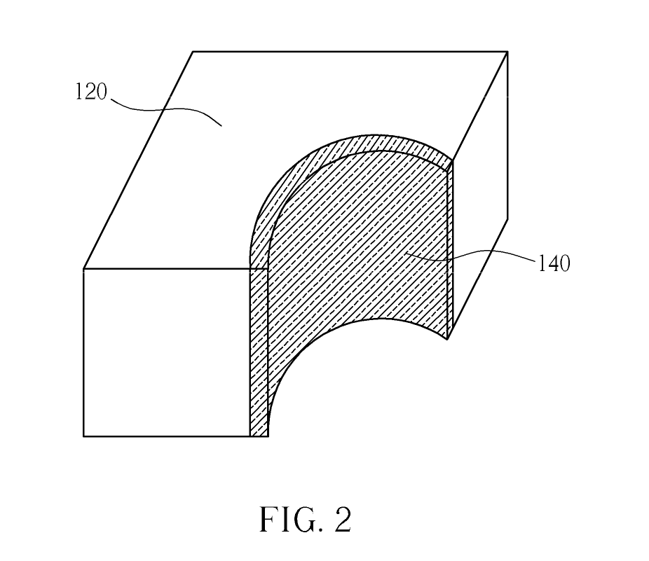

FIG. 1 is a cross-sectional view showing an architecture of a wafer level camera 100 according to a first embodiment of the present invention. The wafer level camera 100 includes, but is not limited to, an image sensor 110, a first spacer layer 120, a wafer level lens module 130, and a plurality of specific thin film layers 140. As shown in FIG. 1, the wafer level lens module 130 includes a first lens plate 131 disposed upon the first spacer layer 120, a second lens plate 133 disposed upon the second spacer layer 132, and a diaphragm 135 disposed upon the third spacer layer 134. Please note that, in this embodiment, the specific thin film layers 140 are disposed on surfaces of the holes within the spacer layers 120 (as shown in FIG. 2), 132 and 134, respectively, but this should not be taken as a limitation of the present invention. In other words, the specific thin film layer can be disposed on any spacer layer of the wafer level camera 100, depending upon the actual design considerations.

By way of example, but not limitation, the wafer level camera 100 may be a compact camera module (CCM) and the wafer level camera 100 may be disposed in an image-capturing device. In addition, the thickness and the number of the specific thin film layers 140 are not limited. That is, various modifications of the thickness and the number of the specific thin film layers 140 may be made without departing from the spirit of the present invention, which also belongs to the scope of the present invention.

In one embodiment, the specific thin film layers 140 are light-shielding layers. And the stray light hit on surfaces of the holes within the spacer layers 120, 132 and 134 will be mostly or fully absorbed by the light-shielding layers. Therefore, the image sensor 110 disposed below the wafer level lens module 130 will not be affected by the undesired stray light, leading to improved image quality. However, the present invention is not limited to this only. That is, other thin film layers capable of substantially avoiding or greatly reducing the light reflection also belong to the scope of the present invention. In addition, the architecture of the wafer level lens module as shown in FIG. 1 is for illustrative purposes, and is not meant to be taken as a limitation of the present invention.

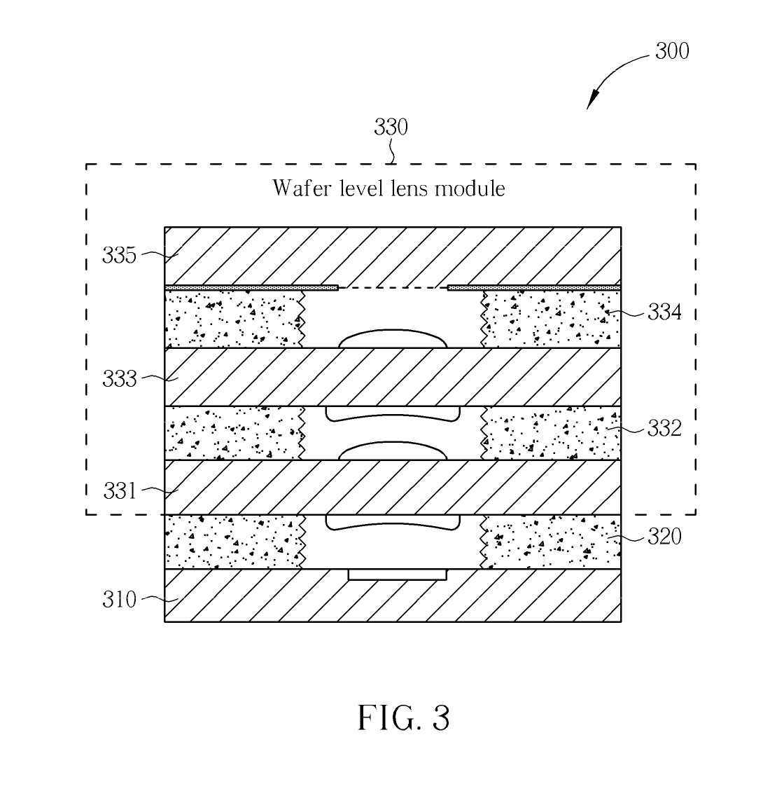

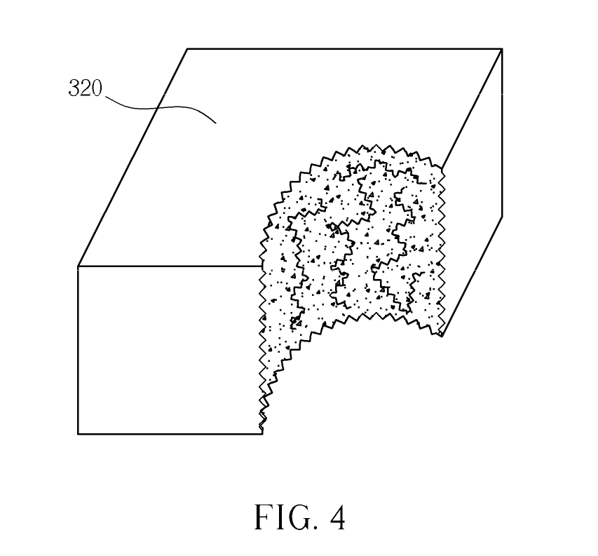

FIG. 3 is a cross-sectional view showing an architecture of a wafer level camera 300 according to a second embodiment of the present invention, which is similar to the wafer level camera 100 shown in FIG. 1. The wafer level camera 300 includes, but is not limited to, an image sensor 310, a first spacer layer 320 and a wafer level lens module 330. As shown in FIG. 3, the wafer level lens module 330 includes a first lens plate 331 disposed upon the first spacer layer 320, a second lens plate 333 disposed upon the second spacer layer 332, and a diaphragm 335 disposed upon the third spacer layer 334. Please note that, in this embodiment, surfaces of the holes within the spacer layers 320 (as shown in FIG. 4), 332 and 334 are rough surfaces, but this should not be construed as a limitation of the present invention. In other words, any surface of the hole within the spacer layer can be a rough surface, depending upon the actual design considerations. When the stray light hits on rough surfaces of the holes within the spacer layers 320, 332 and 334, the incident stray light will be scattered in random scatter directions. In this way, the image sensor 310 will not be seriously affected by the undesired stray light.

The abovementioned embodiments are presented merely to illustrate practicable designs of the present invention, and in no way should be considered to be limitations of the scope of the present invention. Those skilled in the art should appreciate that various modifications of the wafer level camera architectures shown in FIG. 1 and FIG. 3 may be made without departing from the spirit of the present invention.

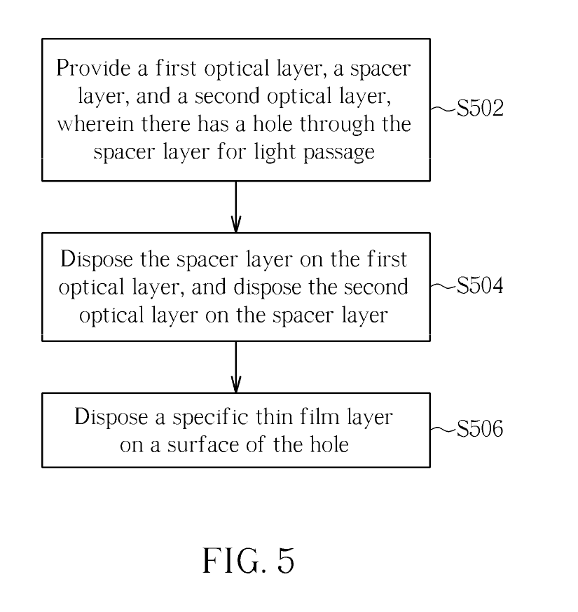

FIG. 5 is a flowchart illustrating a method for forming a wafer level lens module according to an exemplary embodiment of the present invention. Please note that the following steps are not limited to be performed according to the exact sequence shown in FIG. 5 if a substantially identical result can be obtained. The exemplary method includes, but is not limited to, the following steps:

Step 502: Provide a first optical layer, a spacer layer, and a second optical layer, wherein there has a hole through the spacer layer for light passage.

Step 504: Dispose the spacer layer on the first optical layer, and dispose the second optical layer on the spacer layer.

Step 506: Dispose a specific thin film layer on a surface of the hole.

In step 502, the first optical layer can be a lens plate, and the second optical layer can be a diaphragm or a lens plate. In step 506, the specific thin film layer is a light-shielding layer. Other operations of manufacturing a wafer level lens module (e.g. wafer level lens module 130) can be known by collocating the steps shown in FIG. 5 together with the components shown in FIG. 1 and FIG. 2. And further description of each step shown in FIG. 5 is therefore omitted here for brevity.

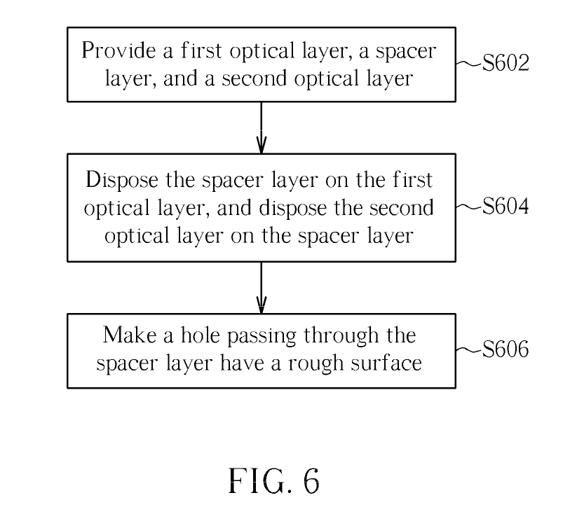

FIG. 6 is a flowchart illustrating a method for forming a wafer level lens module according to another exemplary embodiment of the present invention. The exemplary method includes, but is not limited to, the following steps:

Step 602: Provide a first optical layer, a spacer layer, and a second optical layer.

Step 604: Dispose the spacer layer on the first optical layer, and dispose the second optical layer on the spacer layer.

Step 606: Make a hole passing through the spacer layer have a rough surface.

In step 602, the first optical layer can be a lens plate, and the second optical layer can be a diaphragm or a lens plate. Other operations of manufacturing a wafer level lens module (e.g. wafer level lens module 330) can be known by collocating the steps shown in FIG. 6 together with the components shown in FIG. 3 and FIG. 4. And further description of each step shown in FIG. 6 is therefore omitted here for brevity.

Please note that, the steps of the abovementioned flowcharts are merely exemplary embodiments of the present invention, and in no way should be considered to be limitations of the scope of the present invention. These methods can include other intermediate steps or can merge several steps into a single step without departing from the spirit of the present invention. Those skilled in the art should observe that various modifications of these methods may be made. For example, in an alternative design, the steps shown in FIG. 5 and the steps shown in FIG. 6 can be selectively merged.

In summary, exemplary embodiments of the present invention provide wafer level lens modules, wafer level cameras and related methods for forming the wafer level lens modules. In one exemplary embodiment, the present invention disposes a specific thin film layer on a surface of a hole of a spacer layer of a wafer level camera; therefore, when the stray light hits on the surface of the hole of the spacer layer, the stray light will be absorbed by the specific thin film layer. Thus, an image sensor of the wafer level camera will not be affected by the undesired stray light. In another exemplary embodiment, a spacer layer of a wafer level camera has a rough surface on a hole. When the stray light hits on the rough surface of the hole of the spacer layer, the stray light will be scattered, which protects the image sensor of the wafer level camera from being seriously affected by the undesired stray light. To put it simply, the overall performance of any image-capturing device which employs the technical features of the present invention can be greatly improved.

Those skilled in the art will readily observe that numerous modifications and alterations of the device and method may be made while retaining the teachings of the invention.

What is claimed is:

1. A wafer level lens module, comprising:
a first optical layer;
a spacer layer, disposed upon the first optical layer, having a hole through the spacer layer for light passage, wherein a surface of the hole substantially avoids light reflection; and
a second optical layer, disposed upon the spacer layer.

2. The wafer level lens module of claim 1, wherein a specific thin film layer is disposed on the surface of the hole of the spacer layer.

3. The wafer level lens module of claim 2, wherein the first optical layer comprises a lens plate.

4. The wafer level lens module of claim 2, wherein the second optical layer comprises a diaphragm or a lens plate.

5. The wafer level lens module of claim 2, wherein the specific thin film layer is a light-shielding layer.

6. The wafer level lens module of claim 1, wherein the surface of the hole of the spacer layer is a rough surface.

7. The wafer level lens module of claim 6, wherein the first optical layer comprises a lens plate.

8. The wafer level lens module of claim 6, wherein the second optical layer comprises a diaphragm or a lens plate.

9. A wafer level camera, comprising:
an image sensor;
a spacer layer, disposed upon the image sensor, having a hole through the spacer layer for light passage, wherein a surface of the hole substantially avoids light reflection; and
a wafer level lens module, disposed upon the spacer layer.

10. The wafer level camera of claim 9, wherein a specific thin film layer is disposed on the surface of the hole of the spacer layer.

11. The wafer level camera of claim 10, wherein the specific thin film layer is a light-shielding layer.

12. The wafer level camera of claim 9, wherein the surface of the hole of the spacer layer is a rough surface.

13. A method of forming a wafer level lens module, comprising:
providing a first optical layer, a spacer layer, and a second optical layer, wherein there has a hole through the spacer layer for light passage;
disposing the spacer layer on the first optical layer, and disposing the second optical layer on the spacer layer; and
disposing a specific thin film layer on a surface of the hole.

14. The method of claim 13, wherein the first optical layer comprises a lens plate.

15. The method of claim 13, wherein the second optical layer comprises a diaphragm or a lens plate.

16. The method of claim 13, wherein the specific thin film layer is a light-shielding layer.

17. A method of forming a wafer level lens module, comprising:
providing a first optical layer, a spacer layer, and a second optical layer;
disposing the spacer layer on the first optical layer, and disposing the second optical layer on the spacer layer; and
making a hole passing through the spacer layer have a rough surface.

18. The method of claim 17, wherein the first optical layer comprises a lens plate.

19. The method of claim 17, wherein the second optical layer comprises a diaphragm or a lens plate.
